(19) United States
(12) Patent Application Publication
(10) Pub. No.: US 2011/0159802 A1
(43) Pub. Date: Jun. 30, 2011

(54) RADIO BASE STATION, RADIO TERMINAL DEVICE, RADIO RELAY STATION DEVICE, TRANSMISSION POWER CONTROL METHOD, RADIO COMMUNICATION RELAY METHOD, AND RADIO COMMUNICATION SYSTEM

(75) Inventors: Norharyati Binti Harum, Kanagawa (JP); Yoshikazu Ishii, Kanagawa (JP); Takeshi Kanazawa, Kanagawa (JP)

(73) Assignee: PANASONIC CORPORATION, OSAKA (JP)

(21) Appl. No.: 12/920,882

(22) PCT Filed: Feb. 18, 2009
(86) PCT No.: PCT/JP2009/000654

§ 371 Date: Sep. 3, 2010

(30) Foreign Application Priority Data
Mar. 6, 2008 (JP) 2008-056455

(51) Int. Cl. H04B 7/14

(52) U.S. Cl. 455/7

(57) ABSTRACT

A different resource is allocated to each of a terminal and a relay station as a resource for the communication with a base station. A radio base station device (1) provided in the base station includes: a determination unit (7) which determines whether or not relaying of a random access preamble is performed based on the resource information included in the random access preamble; and a response generating unit (10) which generates a random access response to which relay flag information is attached. When the random access response with the relay flag information attached is transmitted from the base station to the terminal, the control of the transmission power of an RRC connection request is performed at the terminal based on the relay flag information. This allows for the suppression of increase in the delay before the establishment of RRC connection, and thereby a radio base station device which improves the utilization effect of resources is provided.

### TECHNICAL FIELD

The present invention relates to a radio communication system in which a base station, a terminal, and a relay station for relaying radio communication are provided, and particularly to a technique of controlling the transmission power of the terminal depending on whether or not relaying is performed.

### BACKGROUND ART

Conventionally, a network system is known in which radio communication is performed between a base station and a terminal. In such a conventional system, a procedure called an RACH procedure is performed when the terminal is shifted from an idle state to a call procedure. For example, International Publication No. WO05/034554; Japanese Patent Laid-Open No. 2001-560555; 3GPP TS36.300 “E-UTRA and E-UTRAN Overall description stage 2”; 3GPP TSG RAN WG1 meeting #46bis R1-062556, “RACE Design Issues of Large Cell Deployment”, LG Electronics; 3GPP TSG RAN 36.221:E-UTRA MAC Protocol Specification; 3GPP TSG RAN 36.213:5-UTRA Physical Layer Procedure; 3GPP TSG RAN WG2 meeting #60bis R2-080450, “RACE Retransmission modeling” disclose such techniques. When the terminal is shifted from an idle state into a call procedure, an individual channel for communicating with a base station is not yet set. Therefore, the terminal is required to send a signal to the network by using any procedure. What is used at this time for sending a signal to the network by the terminal is a random access channel (also referred to as RACE) of an uplink common transport channel.

In this case, since terminals try to communicate with the network by using an RACH which is a common channel at any time, collisions may possibly take place between multiple terminals. Therefore, a sequence called a signature is used as a preamble such that collision will not occur even if multiple terminals use the same slot at the same time. Preambles with a different signature can be distinguished and detected even if they are received at the same time.

FIG. 11 is a sequence diagram to explain a conventional RACE procedure. As illustrated in FIG. 11, the conventional RACH procedure includes four steps.

In the first step, a terminal transmits a random access preamble to a base station (S1). The base station receives the random access preamble from the terminal and measures the transmission timing of the terminal. In order to transmit data to the base station, the terminal is required to perform uplink synchronization.

In the second step, the base station transmits a random access response to the terminal (S2). The base station instructs, through the random access response, a T-C-RTNI (Temporary Cell Radio Network Temporary Identifier) which is a temporal ID used between the terminal and the base station during an RACH procedure, and a transmission timing of the terminal in and after the third step based on the timing measured in the first step. Moreover, to perform uplink synchronization, the base station instructs, by the random access response, a grant (scheduling grant) for designating the resource of the uplink to be used by the terminal transmitting a message to the base station in the next step.

In the third step, the terminal transmits an RRC (Radio Resource Control) connection request to the base station (S3). The RRC connection request includes the ID of the terminal.

In the fourth step, the base station transmits an RRC connection response to the terminal (S4). This establishes a connection between the terminal and the base station allowing the terminal to enter into a call procedure.

In recent years, in cellular mobile communication systems, technologies for realizing a high transmission rate by use of a high-frequency radio band have been actively studied in order to realize a transmission of large volume data as trends toward multi-media information advance.

However, when a high-frequency radio band is utilized, while a high transmission rate can be expected at short distances, attenuation due to transmission distance increases as the distance increases. Therefore, when operating a mobile communication system that utilizes a high-frequency radio band, the coverage area of a base station becomes smaller thereby requiring the installment of more base stations. Since the installment of base stations requires corresponding costs, there is a strong need for a technology for realizing communication services that utilize a high-frequency radio band while suppressing the increase in the number of base stations.

For such a need, a study has been conducted on the introduction of a relay station which serves to relay the communication between the base station and the terminal into a network system to enlarge the coverage area of each base station. For example, IEEE P802.16j/D1 (August 2007) “Part 16: Interface for Fixed and Mobile Broadband Wireless Access Systems” and WIRELESS WORLD RESEARCH FORUM “White Paper on Multi-hop Protocols for Relay based on Deployment Concept” disclose such a technology. Such relay station is disposed at a cell edge portion of the base station for the purpose of increasing the received power at a cell edge of the base station. The relay station belongs to at least one base station in the vicinity, and has a function to relay the communication between the concerned base station and the terminal.

FIG. 12 is an explanatory diagram to illustrate an example of the relay station. FIG. 12 illustrates control plane (C-plane) protocols, which are protocols for the control signals of the terminal (UE), the relay station (RN), and the base station (eNB). The relay station illustrated in FIG. 12 is a layer 2 relay which has functions up to layer 2, and is also called as a layer 2 repeater, a MAC relay, and a MAC repeater. The layer 2 relay has functions of scheduling, error correction, retransmission, and so on.

FIG. 13 is a sequence diagram to illustrate the flow of an RACH procedure when a relay station is simply introduced into a conventional network system. The example of FIG. 13 shows the flow of the RACH procedure when a terminal that camps on the base station is located out of the communication cell of the relay station and in a place closer to the relay station than to the base station.

In this case, although the terminal and the base station are communicating, the relay station as well can receive the signal (upward signal) transmitted to the base station by the terminal since the terminal is located in a place close to the relay station. However, as described above, since the terminal is located out of the communication cell of the relay station, the terminal cannot receive the signal (downward signal) from the relay station.

It is noted that if the relay station uses the same access slot as that of the base station to which it connects in an RACH procedure, it becomes impossible to identify, based on the access slot, on which of the base station and the relay station the terminal camps. In this case, allocating a different signature to each of the relay station and the base station makes it possible to identify on which of the base station and the relay station the terminal camps from a random access preamble.

As illustrated in FIG. 13, first, the terminal transmits a random access preamble to the base station (S10). However, when the terminal is located at an edge portion (portion of the border) of the communication cell of the base station, there is a chance that the random access preamble does not reach the base station. Here, since the relay station and the base station use the same access slot, the relay station can receive the random access preamble transmitted to the base station by the terminal.

The relay station that has received the random access preamble from the terminal to the base station transfers the random access preamble to the base station, when the signature of the random access preamble is the signature that is allocated to the relay station itself, or the signature of the base station to which the relay station connects (S11). Thus, when the random access preamble does not directly reach the base station from the terminal, the random access preamble is relayed at the relay station, and therefore it is possible to prevent the retransmission of the random access preamble (retransmission by the terminal).

When the base station receives a random access preamble with the signature that is allocated to itself, the base station transmits a random access response to the terminal (S12). In this case, since the signature included in the preamble is that for the base station, the base station transmits a random access response directly to the terminal regardless whether the random access preamble is received directly from the terminal or from the relay station.

Upon receiving the random access response, the terminal transmits an RRC connection request directly to the base station (S13). When the RRC connection request does not reach the base station, the terminal retransmits the RRC connection request (S14).

In such a network system, even when the terminal is located at an edge portion (portion of the border) of the communication cell of the base station and a random access preamble does not directly reach the base station, transferring (relaying) of the random access preamble is performed by the relay station that uses the same access slot as that of the base station allowing the base station to receive the random access preamble.

However, in the above described network system, the base station transmits a random access response directly to the terminal regardless of whether or not the relaying of the random access preamble has been performed. In that case, even if the random access preamble does not directly reach the base station (for example, the transmission power is insufficient), the terminal cannot recognize that.

For example, in a system in which the terminal directly transmits an RRC connection request with reference to the transmission power of random access preamble (at the same transmission power as that for the random access preamble), the RRC connection request will not reach the base station due to the insufficiency of the transmission power, and thereby the retransmission of the RRC connection request becomes necessary, resulting in an increase in the delay before an RRC connection is established. Moreover, since the resource that is required for the retransmission of the RRC connection request is additionally needed, the utilization effect of resources (resource utilization ratio) will decline. Moreover, for example, in a system in which when the number of transmissions of RRC connection request exceeds a maximum number of transmission, the terminal resumes the RACH procedure from the start (from the transmission of random access preamble), a further increase in the delay and a decline of the resource utilization efficiency will result.

### DISCLOSURE OF THE INVENTION

### Problems to be Solved by the Invention

The present invention has been made under the background described above. It is an object of the present invention to provide a radio base station device which can suppress the increase in the delay before the establishment of RRC connection, thereby improving the utilization effect of resources.

### Means for Solving the Problems

An aspect of the present invention is a radio base station device to be used in a base station in a radio communication system in which a relay station for relaying radio communication between the base station and a terminal is disposed in a communication cell of the base station, wherein a different resource is allocated to each of the terminal and the relay station as a resource for communication with the base station, the radio base station device comprising: a preamble receiving unit for receiving a random access preamble transmitted from the terminal; a relay determination unit for determining whether or not relaying of the random access preamble has been performed, based on resource information included in the random access preamble; a response generating unit for generating a random access response with relay flag information attached that indicates whether or not relaying of the random access preamble has been performed, based on a determination result of the relay determination unit; and a response transmitting unit for transmitting the random access response to the terminal, wherein relay flag information that indicates that relaying of the random access preamble has been performed is a power control request that instructs the terminal to control transmission power.

Another aspect of the present invention is a radio terminal device to be used in a terminal in a radio communication system in which a relay station for relaying radio communication between a base station and a terminal is disposed in a communication cell of the base station, wherein relay flag information that indicates whether or not relaying of the random access preamble has been performed is attached to a random access response which is transmitted from the base station to the terminal as a response to the random access preamble transmitted from the terminal to the base station, the radio terminal device comprising: a response receiving unit for receiving a random access response transmitted from the base station; a message transmitting unit for transmitting a connection request message to the base station; and a transmission power control unit for controlling a transmission power of the connection request message based on relay flag information that indicates that relaying of the random access preamble has been performed.

A further aspect of the present invention is a radio relay station device to be used in a relay station in a radio communication system in which the relay station for relaying radio communication between a base station and a terminal is disposed in a communication cell of the base station, wherein relay information to be used for relaying a connection request message transmitted from the terminal is included in scheduling information which is transmitted from the base station when relaying of a random access preamble transmitted from the terminal to the base station has been performed, the radio relay station device comprising: a scheduling information receiving unit for receiving scheduling information transmitted from the base station; a message receiving unit for receiving a connection request message transmitted from the terminal; and a message relaying unit for relaying the connection request message to the base station based on the scheduling information.

A further aspect of the present invention is a method of controlling transmission power to be used in a base station in a radio communication system in which a relay station for relaying radio communication between a base station and a terminal is disposed in a communication cell of the base station, wherein a different resource is allocated to each of the terminal and the relay station as a resource for communication with the base station, the method comprising: receiving a random access preamble transmitted from the base station; determining whether or not relaying of the random access preamble has been performed, based on resource information included in the random access preamble; generating a random access response with relay flag information attached that indicates whether or not relaying of the random access preamble has been performed, based on the determination result; transmitting the random access response to the terminal; and instructing the terminal to control transmission power by using the relay flag information that indicates that relaying of the random access preamble has been performed.

A further aspect of the present invention is a method of controlling transmission power to be used in a terminal in a radio communication system in which a relay station for relaying radio communication between a base station and a terminal is disposed in a communication cell of the base station, wherein relay flag information that indicates whether or not relaying of a random access preamble has been performed, is attached to a random access response transmitted from the base station to the terminal as a response to the random access preamble transmitted from the terminal to the base station, the method comprising: receiving the random access response transmitted from the base station; and controlling the transmission power of a connection request message based on relay flag information that indicates that relaying of the random access preamble has been performed, when transmitting the connection request message to the base station.

A further aspect of the present invention is a method of relaying radio communication to be used in a relay station in a radio communication system in which the relay station for relaying radio communication between a base station and a terminal is disposed in a communication cell of the base station, wherein relay information to be used for relaying a connection request message transmitted from the terminal is included in scheduling information which is transmitted from the base station when relaying of a random access preamble transmitted from the terminal to the base station has been performed, the method comprising: receiving scheduling information transmitted from the base station; receiving a connection request message transmitted from the terminal; and relaying the connection request message to the base station based on the scheduling information.

A further aspect of the present invention is a radio communication system in which a relay station for relaying radio communication between a base station and a terminal is disposed in a communication cell of the base station, wherein a different resource is allocated to each of the terminal and the relay station as a resource for communication with the base station, wherein the base station comprises: a preamble receiving unit for receiving a random access preamble transmitted from the terminal; a relay determination unit for determining whether or not relaying of the random access preamble has been performed based on resource information included in the random access preamble; a response generating unit for generating a random access response with relay flag information attached that indicates whether or not relaying of the random access preamble has been performed, based on a determination result of the determination unit; and a response transmitting unit for transmitting the random access response to the terminal, and wherein the terminal comprises: a response receiving unit for receiving the random access response transmitted from the base station; a message transmitting unit for transmitting a connection request message to the base station; and a transmission power control unit for controlling a transmission power of the connection request message based on the relay flag information attached to the random access response.

As described below, there are other aspects in the present invention. Therefore, this disclosure of the invention is intended to provide some aspects of the present invention and not intended to limit the scope of the invention herein set forth and claimed.

### BRIEF DESCRIPTION OF THE DRAWINGS

FIG. 1 is a block diagram to illustrate the configurations of a radio base station device and a radio terminal device in the present embodiment;

FIG. 2 is an explanatory diagram to illustrate the positional relationship among a base station, a terminal, and a relay station in the present embodiment;

FIG. 3 is a block diagram to illustrate the configuration of a radio relay station device in the present embodiment;

FIG. 4 is a sequence diagram to illustrate the flow of an RACH procedure in the present embodiment;

FIG. 5 is a flow diagram to illustrate the flow of operation of the radio base station device in the RACH procedure;

FIG. 6 is a flow diagram to illustrate the flow of the operation of the radio terminal device in the RACH procedure;

FIG. 7 is a flow diagram to illustrate the flow of operation of the radio relay station device in the RACH procedure;

FIG. 8 is a sequence diagram to illustrate the flow of the RACH procedure when CQI is low in the present embodiment;

FIG. 9 is a flow diagram to illustrate the flow of operation of the radio base station device in the RACH procedure when CQI is low;

FIG. 10 is a flow diagram to illustrate the flow of operation of the radio relay station device in the RACH procedure when CQI is low;

FIG. 11 is a sequence diagram to describe a conventional RACH procedure;

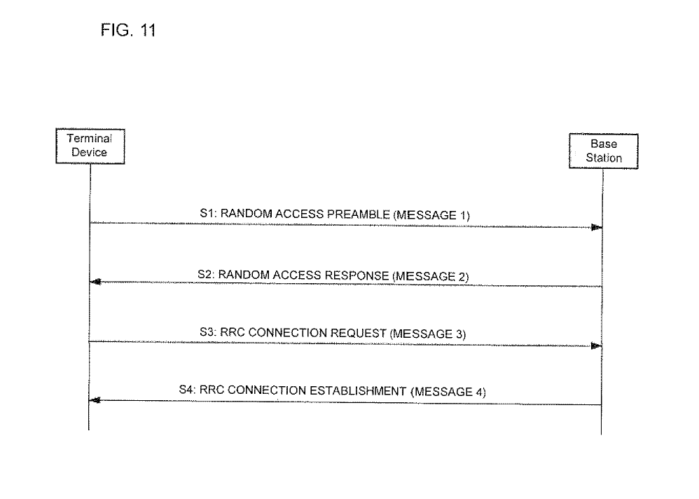

FIG. 12 is an explanatory diagram to illustrate an example of the relay station; and

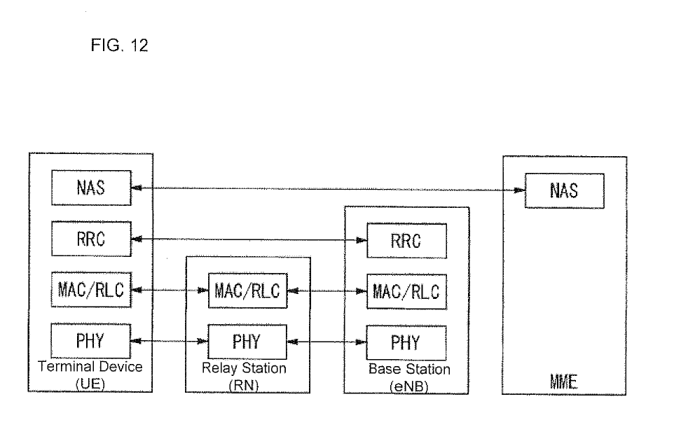

FIG. 13 is a sequence diagram to illustrate the flow of the RACH procedure.

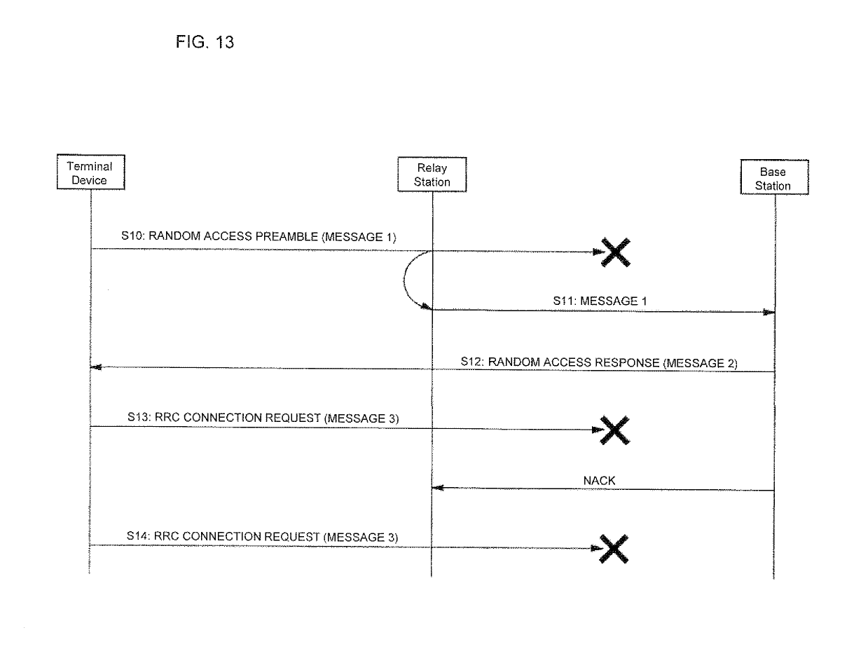

### DESCRIPTION OF SYMBOLS

1 Radio base station device
2 Radio terminal device
3 Radio relay station device
4 Receiving unit
5 Preamble acquiring unit
6 RRC connection request acquiring unit
7 Determination unit
8 Control unit
9 Scheduler unit
10 Response generating unit
11 Scheduling information generating unit
12 Transmitting unit
13 Receiving unit
14 Reference signal acquiring unit
15 Response acquiring unit
16 Broadcast information acquiring unit
17 RRC connection response acquiring unit
18 Determination unit
19 Control unit
20 Resource storing unit
21 Preamble generating unit
22 RRC connection request generating unit
23 Transmitting unit
24 Receiving unit
25 Preamble storing unit
26 Scheduling information acquiring unit
27 RRC connection request acquiring unit
28 Determination unit
29 Control unit
30 Resource storing unit
31 Transmitting unit

### BEST MODE FOR PERFORMING THE INVENTION

Hereafter, the present invention will be described in detail. However, the detailed description below and the appended drawings will not limit the invention. Instead, the scope of the invention is defined by the appended claims.

The radio base station device of the present invention is a radio base station device to be used in a base station in a radio communication system in which a relay station for relaying radio communication between the base station and a terminal is disposed in a communication cell of the base station, wherein a different resource is allocated to each of the terminal and the relay station as a resource for communication with the base station, the radio base station device comprising: a preamble receiving unit for receiving a random access preamble transmitted from the terminal; a relay determination unit for determining whether or not relaying of the random access preamble has been performed, based on resource information included in the random access preamble; a response generating unit for generating a random access response with relay flag information attached that indicates whether or not relaying of the random access preamble has been performed, based on a determination result of the relay determination unit; and a response transmitting unit for transmitting the random access response to the terminal, and configured such that relay flag information that indicates that relaying of the random access preamble has been performed is a power control request that instructs the terminal to control transmission power.

According to this configuration, at the base station, determination is made on whether or not relaying of a random access preamble has been performed based on the resource information of the random access preamble. For example, if the resource of the random access preamble is a resource allocated to the terminal, it is determined that the random access preamble has been received directly from the terminal (without relaying). On the other hand, if the random access preamble is a resource allocated to the relay station, it is determined that the random access preamble has been relayed at the relay station (with relaying). Then, relay flag information that indicates whether or not relaying has been performed is attached to the random access response to be transmitted to the terminal. At the terminal, the transmission power is controlled based on the relay flag information. For example, based on the relay flag information that indicates that relaying has been performed, a control to increase the transmission power is performed. In this way, the use of relay flag information allows the terminal to recognize that when the random access preamble has not directly reached the base station (that is, when relaying has been performed). This enables the terminal to perform the control of transmission power depending on whether or not relaying has been performed. For example, when relaying has been performed, a control to increase the transmission power of RRC connection request is performed, thereby allowing for the reduction of retransmissions of RRC connection request caused by the insufficiency of transmission power. In this way, it is possible to suppress the delay before the establishment of RRC connection, thereby improving the utilization effect of resources.

Moreover, the radio base station device of the present invention may be configured to include a scheduling information generating unit for generating scheduling information including relay information to be used for relaying a connection request message transmitted from the terminal, when it is determined by the relay determination unit that relaying of a random access preamble has been performed; and a scheduling information transmitting unit for transmitting the scheduling information to the relay station.

According to this configuration, when a random access preamble has not directly reached the base station (that is, when relaying has been performed), scheduling information is transmitted to the relay station. The scheduling information includes relay information (for example, a grant for RRC connection request and a resource for relaying) to be used for relaying a connection request message transmitted from the terminal. This enables the relay station to relay an RRC connection request which is thereafter to be transmitted to the base station by the terminal. For example, depending on the position and situation, etc. of the terminal, such as when the terminal is located at a cell edge, the RRC connection request may not directly reach the base station even if the control of the transmission power of the terminal is performed as described above. In such a case, the RRC connection request is relayed by the relay station that has received scheduling information. This allows for the reduction of retransmissions of RRC connection request.

Moreover, the radio base station device of the present invention may be configured such that the random access preamble transmitted from the terminal includes communication quality information that indicates a level of communication quality (high level/low level) between the terminal and the base station; and the relay determination unit determines that the relaying of the random access preamble has been performed when the communication quality is low.

According to this configuration, the random access preamble includes communication quality information (for example, information of CQI) between the terminal and the base station so that when the communication quality (CQI) is low, it is determined (estimated) that relaying has been performed. For example, depending on the position and situation, etc. of the terminal, such as when the terminal is located at a cell edge, a next RRC connection request may not directly reach the base station even if a preceding random access preamble has directly reached the base station. In such a case, it is determined (estimated) whether or not relaying has been performed with reference to the communication quality (CQI) of the terminal. This allows for the reduction of retransmissions of PRO connection request.

The radio terminal device of the present invention is a radio terminal device to be used in a terminal in a radio communication system in which a relay station for relaying radio communication between a base station and a terminal is disposed in a communication cell of the base station, wherein relay flag information that indicates whether or not relaying of the random access preamble has been performed is attached to a random access response which is transmitted from the base station to the terminal as a response to the random access preamble transmitted from the terminal to the base station, the radio terminal device is configured to include: a response receiving unit for receiving a random access response transmitted from the base station; a message transmitting unit for transmitting a connection request message to the base station; and a transmission power control unit for controlling transmission power of the connection request message based on relay flag information that indicates that relaying of the random access preamble has been performed.

According to this configuration, at the terminal, control of the transmission power is performed based on the relay flag information transmitted from the base station. For example, a control to increase the transmission power is performed based on relay flag information that indicates that relaying has been performed. Thus receiving relay flag information enables the terminal to recognize that when a random access preamble has not directly reached the base station (that is, when relaying has been performed). This enables the terminal to control the transmission power depending on whether or not relaying has been performed when transmitting an RRC connection request. For example, when relaying has been performed, a control to increase the transmission power of RRC connection request is performed. This allows for the reduction of retransmissions of RRC connection request caused by the insufficiency of transmission power. In this way, it is possible to suppress the delay before the establishment of RRC connection, thereby improving the utilization effect of resources.

Further, the radio terminal device of the present invention may be configured such that the transmission power control unit controls the transmission power of the connection request message so as to be larger than the transmission power of the random access preamble based on relay flag information that indicates that relaying of the random access preamble has been performed.

According to this configuration, at the terminal, a control to increase the transmission power of RRC connection request is performed when relaying of random access preamble has been performed. This allows for the reduction of retransmissions of RRC connection request caused by the insufficiency of transmission power. In this way, it is possible to suppress the delay before the establishment of RRC connection, thereby improving the utilization effect of resources.

Moreover, the radio terminal device of the present invention may be configured such that the transmission power control unit controls transmission power of the connection request message in accordance with the received signal strength of the random access response.

According to this configuration, at the terminal, a control of the transmission power of the RRC connection request (so called an open power control) is performed in accordance with the received signal strength of the random access response. For example, when the received signal strength of the random access response is low, a control to increase the transmission power of RRC connection request is performed. This allows for the reduction of retransmissions of RRC connection request caused by the insufficiency of transmission power. In this way, it is possible to suppress the delay before the establishment of RRC connection, thereby improving the utilization effect of resources.

The radio relay station device of the present invention is a radio relay station device to be used in a relay station in a radio communication system in which the relay station for relaying radio communication between a base station and a terminal is disposed in a communication cell of the base station, wherein relay information to be used for relaying a connection request message transmitted from the terminal is included in scheduling information which is transmitted from the base station when relaying of a random access preamble transmitted from the terminal to the base station has been performed, the radio relay station device configured to include: a scheduling information receiving unit for receiving scheduling information transmitted from the base station; a message receiving unit for receiving a connection request message transmitted from the terminal; and a message relaying unit for relaying the connection request message to the base station based on the scheduling information.

According to this configuration, when a random access preamble has not directly reached the base station (that is, when relaying has been performed), scheduling information is transmitted to the relay station. This scheduling information includes relay information (for example, a grant for RRC connection request and a resource for relaying) to be used for relaying the connection request message transmitted from the terminal. This enables the relay station to relay an RRC connection request which is thereafter to be transmitted to the base station by the terminal. For example, depending on the position and situation, etc. of the terminal, such as when the terminal is located at a cell edge, the RRC connection request may not directly reach the base station even if the control of the transmission power of the terminal is performed as described above. In such a case, the RRC connection request is relayed by the relay station that has received scheduling information. This allows for the reduction of retransmissions of RRC connection request. Therefore, it is possible to suppress the delay before the establishment of RRC connection, thereby improving the utilization effect of resources.

The method of controlling transmission power of the present invention is a method to be used in a base station in a radio communication system in which a relay station for relaying radio communication between a base station and a terminal is disposed in a communication cell of the base station, wherein a different resource is allocated to each of the terminal and the relay station as a resource for communication with the base station, the method configured to include: receiving a random access preamble transmitted from the base station; determining whether or not relaying of the random access preamble has been performed, based on resource information included in the random access preamble; generating a random access response with relay flag information attached that indicates whether or not relaying of the random access preamble has been performed, based on the determination result; transmitting the random access response to the terminal; and instructing the terminal to control transmission power by using the relay flag information that indicates that relaying of the random access preamble has been performed.

According to this method, at the base station, determination is made on whether or not relaying of the random access preamble has been performed based on the resource information of the random access preamble. For example, when the resource of the random access preamble is a resource allocated to the terminal, it is determined that the random access preamble has been received directly from the terminal (without relaying). On the other hand, when the resource of the random access preamble is a resource allocated to the relay station, it is determined that the random access preamble has been relayed at the relay station (with relaying). Then, relay flag information that indicates whether or not relaying has been performed is attached to the random access response to be transmitted to the terminal. At the terminal, the transmission power is controlled based on the relay flag information. For example, based on the relay flag information that indicates that relaying has been performed, a control to increase the transmission power is performed. In this way, the use of relay flag information allows the terminal to recognize that when the random access preamble has not directly reached the base station (that is, when relaying has been performed). This enables the terminal to perform the control of transmission power depending on whether or not relaying has been performed. For example, when relaying has been performed, a control to increase the transmission power of RRC connection request is performed, thereby allowing for the reduction of retransmissions of RRC connection request caused by the insufficiency of transmission power. In this way, it is possible to suppress the delay before the establishment of RRC connection, thereby improving the utilization effect of resources.

The method of controlling transmission power of the present invention is a method to be used in a terminal in a radio communication system in which a relay station for relaying radio communication between a base station and a terminal is disposed in a communication cell of the base station, wherein relay flag information that indicates whether or not relaying of a random access preamble has been performed is attached to a random access response transmitted from the base station to the terminal as a response to the random access preamble transmitted from the terminal to the base station, the method configured to include: receiving a random access response transmitted from the base station; and controlling transmission power of a connection request message based on relay flag information that indicates that relaying of the random access preamble has been performed, when transmitting the connection request message to the base station.

According to this method, at the terminal, the control of transmission power is performed based on relay flag information transmitted from the base station. For example, based on relay flag information that indicates that relaying has been performed, a control to increase the transmission power is performed. In this way, the reception of relay flag information allows the terminal to recognize that when the random access preamble has not directly reached the base station (that is, when relaying has been performed). This enables the terminal to perform the control of transmission power depending on whether or not relaying has been performed, when transmitting an RRC connection request. For example, when relaying has been performed, a control to increase the transmission power of RRC connection request is performed. This allows for the reduction of retransmissions of RRC connection request caused by the insufficiency of transmission power. In this way, it is possible to suppress the delay before the establishment of PRO connection, thereby improving the utilization effect of resources.

The method of relaying radio communication of the present invention is a method to be used in a relay station in a radio communication system in which the relay station for relaying radio communication between a base station and a terminal is disposed in a communication cell of the base station, wherein relay information to be used for relaying a connection request message transmitted from the terminal is included in scheduling information which is transmitted from the base station when relaying of a random access preamble transmitted from the terminal to the base station has been performed, the method including: receiving scheduling information transmitted from the base station; receiving a connection request message transmitted from the terminal; and relaying the connection request message to the base station based on the scheduling information.

According to this configuration, when a random access preamble has not directly reached the base station (that is, when relaying has been performed), scheduling information is transmitted to the relay station. This scheduling information includes relay information (for example, a grant for RRC connection request and a resource for relaying) to be used for relaying the connection request message transmitted from the terminal. This enables the relay station to relay the RRC connection request which is thereafter to be transmitted to the base station by the terminal. For example, depending on the position and situation, etc. of the terminal, such as when the terminal is located at a cell edge, the RRC connection request may not directly reach the base station even if the control of the transmission power of the terminal is performed as described above. In such a case, the RRC connection, request is relayed by the relay station that has received scheduling information. This allows for the reduction of retransmissions of RRC connection request. Therefore, it is possible to suppress the delay before the establishment of RRC connection, thereby improving the utilization effect of resources.

The radio communication system of the present invention is a radio communication system in which a relay station for relaying radio communication between a base station and a terminal is disposed in a communication cell of the base station, wherein a different resource is allocated to each of the terminal and the relay station as a resource for communication with the base station, wherein the base station comprises: a preamble receiving unit for receiving a random access preamble transmitted from the terminal; a relay determination unit for determining whether or not relaying of the random access preamble has been performed based on resource information included in the random access preamble; a response generating unit: for generating a random access response with relay flag information attached that indicates whether or not relaying of the random access preamble has been performed, based on a determination result of the determination unit; and a response transmitting unit for transmitting the random access response to the terminal, and wherein the terminal comprises: a response receiving unit for receiving the random access response transmitted from the base station; a message transmitting unit for transmitting a connection request message to the base station; and a transmission power control unit for controlling the transmission power of the connection request message based on the relay flag information attached to the random access response.

According to this configuration, at the base station, determination is made on whether or not relaying of a random access preamble has been performed based on the resource information of the random access preamble. For example, if the resource of the random access preamble is a resource allocated to the terminal, it is determined that the random access preamble has been received directly from the terminal (without relaying). On the other hand, if the random access preamble is a resource allocated to the relay station, it is determined that the random access preamble has been relayed at the relay station (with relaying). Then, relay flag information that indicates whether or not relaying has been performed is attached to the random access response to be transmitted to the terminal. At the terminal, the transmission power is controlled based on the relay flag information. For example, based on the relay flag information that indicates that relaying has been performed, a control to increase the transmission power is performed. In this way, the use of relay flag information allows the terminal to recognize that when the random access preamble has not directly reached the base station (that is, when relaying has been performed). This enables the terminal to perform the control of transmission power depending on whether or not relaying has been performed. For example, when relaying has been performed, a control to increase the transmission power of RRC connection request is performed, thereby allowing for the reduction of retransmissions of RRC connection request caused by the insufficiency of transmission power. In this way, it is possible to suppress the delay before the establishment of RRC connection, thereby improving the utilization effect of resources.

Moreover, the radio communication system of the present invention may be configured such that the base station includes: a scheduling information generating unit for generating scheduling information including relay information to be used for relaying a connection request message to be transmitted from the terminal when it is determined by the relay determination unit that relaying of the random access preamble has been performed; and a scheduling information transmitting unit for transmitting the scheduling information to the relay station, and wherein the relay station includes: a scheduling information receiving unit for receiving scheduling information transmitted from the base station; a message receiving unit for receiving a connection request message transmitted from the terminal; and a message relaying unit for relaying the connection request message to the base station based on the scheduling information.

According to this configuration, when a random access preamble has not directly reached the base station (that is, when relaying has been performed), scheduling information is transmitted to the relay station. The scheduling information includes relay information (for example, a grant for RRC connection request and a resource for relaying) to be used for relaying a connection request message transmitted from the terminal. This enables the relay station to relay an RRC connection request which is thereafter to be transmitted to the base station by the terminal. For example, depending on the position and situation, etc. of the terminal, such as when the terminal is located at a cell edge, the RRC connection request may not directly reach the base station even if the control of the transmission power of the terminal is performed as described above. In such a case, the RRC connection request is relayed by the relay station that has received scheduling information. This allows for the reduction of retransmissions of RRC connection request.

The present invention can suppress the increase in the delay before the establishment of RRC connection thereby improving the utilization effect of resources, by determining whether or not relaying of random access preamble has been performed at the base station, transmitting a random access response with relay flag information attached to the terminal, and controlling the transmission power of the terminal.

Hereafter, a network system of an embodiment of the present invention will be described by using the drawings. The network system of the present embodiment includes a base station, a terminal (such as a portable phone and a PDA), and a relay station (relay node). The base station is provided with a radio base station device, and the terminal is provided with a radio terminal device. Moreover, the relay station is provided with a radio relay station device.

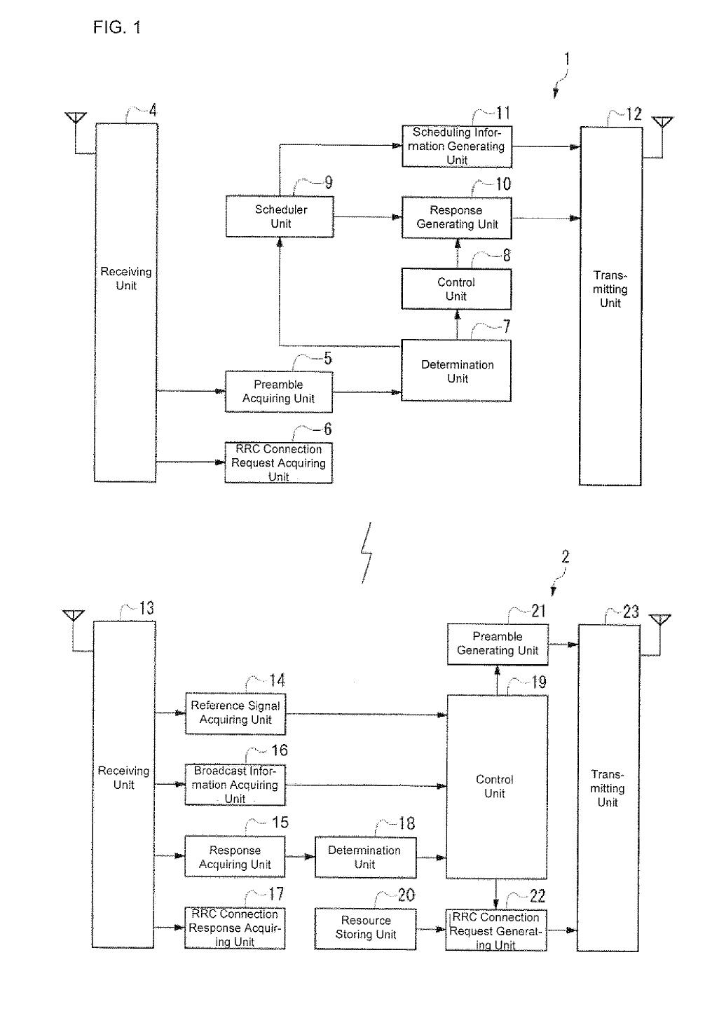

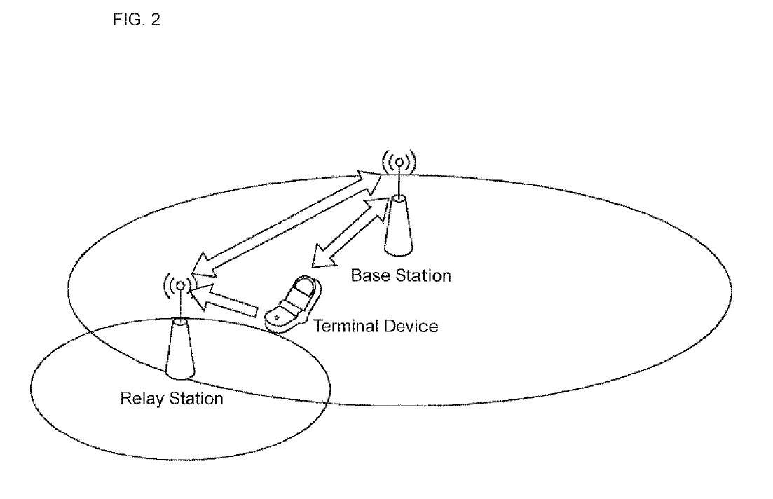

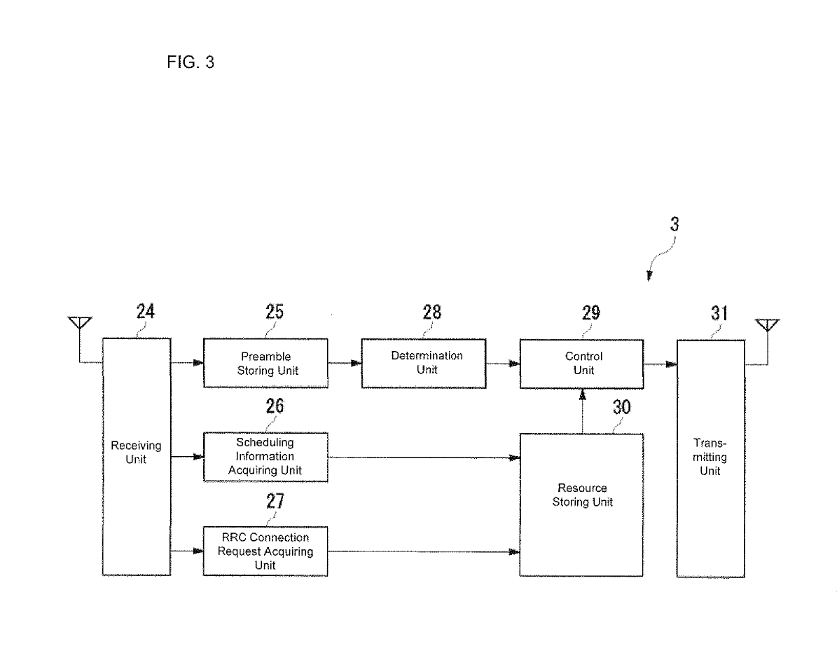

The network system of the embodiment of the present invention will be described using FIGS. 1 to 10. FIG. 1 is a block diagram to illustrate the configurations of the radio base station device and the radio terminal device; and FIG. 2 is a conceptual diagram to explain the positional relationship among the base station, the terminal, and the relay station. Moreover, FIG. 3 is a block diagram to illustrate the configuration of the radio relay station device.

First, with reference to FIG. 2, the area configurations of the base station and the relay station of the present embodiment will be described. As illustrated in FIG. 2, the area of the base station is larger than that of the relay station. In this example, a terminal which camps on the base station is located outside the communication cell of the relay station and in a place closer to the relay station than to the base station.

In such a case, even though the terminal and the base station are communicating with each other, the relay station as well can receive the signal (upward signal) transmitted to the base station by the terminal, since the terminal is located in a place close to the relay station. However, since the terminal is located outside the communication cell of the relay station as described above, the terminal cannot receive the signal (downward signal) from the relay station.

Moreover, in the present embodiment, the communication from the terminal to the relay station and the communication from the terminal to the base station are performed using the same access slot in an RACH procedure. For that reason, the relay station as well can receive a random access preamble (also called an RACH preamble) which is transmitted to the base station by the terminal. Therefore, although the terminal is communicating with the base station, the relay station as well can receive the signal transmitted to the base station by the terminal, when the terminal enters into the area of the relay station. Thus, use of the same access slot by the relay station and the base station in an RACH procedure allows the RACH procedure to be continued even when the terminal moves from the area of the base station to that of the relay station during the RACH procedure.

Next, with reference to FIGS. 1 and 3, the configurations of a radio base station device 1, a radio terminal device 2, and a radio relay station device 3 will be described.

### (Radio Base Station Device)

First, the configuration of the radio base station device 1 will be described. As illustrated in FIG. 1, the radio base station device 1 includes a receiving unit 4, a random access preamble acquiring unit 5 (also simply referred to as a preamble acquiring unit), an RRC connection request acquiring unit 6, a determination unit 7, and a control unit 8. Moreover, the radio base station device 1 includes a scheduler unit 9, a random access response generating unit 10 (also simply referred to as a response generating unit), a scheduling information generating unit 11, and a transmitting unit 12.

The receiving unit 4 receives messages transmitted from the terminal and the relay station in an RACH procedure. To be specific, the receiving unit 4 receives a random access preamble and an RRC connection request, etc. from the terminal and the relay station. Here, the receiving unit 4 corresponds to the preamble receiving unit of the present invention.

The preamble acquiring unit 5 acquires a random access preamble inputted from the receiving unit 4 and outputs the same to the determination unit 7. Moreover, the preamble acquiring unit 5 confirms a CQI included in the random access preamble received at the receiving unit 4 and outputs the same to the determination unit 7.

The determination unit 7 determines a signature of the random access preamble inputted from the preamble acquiring unit 5. In this case, a different signature is allocated to each of the base station and the relay station. When the terminal transmits a random access preamble directly to the base station, the signature allocated to the base station is used. On the other hand, when the terminal transmits a random access preamble to the base station via the relay station, the signature allocated to the relay station is used.

When a random access preamble with the signature for the base station is received, a T-C-RNTI (Temporary Cell Radio Network Temporary Identifier) of the base station and the resource (grant) for the uplink between the terminal and the base station are notified to the response generating unit 10. The resource for the uplink between the terminal and the base station is allocated at the scheduler unit 9. Then, a random access response generated at the response generating unit 10 is transmitted from the transmitting unit 12 to the terminal.

On the other hand, when a random access preamble with the signature for the relay station is received, the T-C-RNTI (Temporary Cell Radio Network Temporary Identifier) of the base station, the resource for the uplink between the terminal and the relay station, and the resource grant) for the uplink between the relay station and the base station are notified to the response generating unit 10. In the same manner as described above, the resource for the uplink between the terminal and the relay station and the resource for the uplink between the relay station and the base station are allocated at the scheduler unit 9. Then, a random access response generated at the response generating unit 10 is transmitted from the transmitting unit 12 to the terminal.

The present invention assumes, as described above, that a terminal that camps on a base station is located outside the communication cell of a relay station and in a place closer to the relay station than to the base station (see FIG. 2). In such a situation, there is a chance that relaying is performed by the relay station even for a terminal that camps on the base station. Then, in such a case, it may be desirable for the terminal to change over to a relaying with the relay station rather than to continue the direct communication with the base station.

Then, at the determination unit 7, when a random access preamble with the signature for the base station is received, the determination of the resource of the random access preamble is performed. A different resource is allocated to each of the terminal and the relay station as the resource for the communication with the base station, and the random access preamble includes the information (resource information) of the resource that is used in the communication with the base station. The determination unit 7 determines whether or not relaying of a random access preamble has been performed based on the resource information included in the random access preamble.

For example, when a random access preamble with the resource for the communication between the terminal and the base station is received, it is determined that relaying of the random access preamble has not been performed. On the other hand, when a random access preamble with the resource for the communication between the relay station and the base station is received, it is determined that relaying of the random access preamble has been performed (via the relay station). Here, the determination unit 7 corresponds to the relay determination unit of the present invention.

The control unit 8 adds a “via-relay-station flag” which indicates a random access preamble path. When it is determined to be via the relay station at the determination unit 7, the control unit 8 is instructed to add a “via-relay-station flag”. The “via-relay-station flag” added at the control unit 8 is outputted to the response generating unit 10. Here, the via-relay-station flag corresponds to the relay flag information of the present invention. For this via-relay-station flag, for example, one bit information (with or without relaying) will be sufficient.

At the response generating unit 10, a random access response including a via-relay-station flag is generated. To be more specific, the response generating unit 10 generates a random access response message from the resource inputted from the scheduler unit 9. For example, when the signature for the base station is utilized, a random access response message including a grant between the terminal and the base station, and a T-C-RNTI is generated. The generated random access response message is outputted to the transmitting unit 12. Here, the response generating unit 10 corresponds to the response generating unit of the present invention.

The transmitting unit 12 transmits the random access response message inputted from the response generating unit 10 to the terminal. Here, the transmitting unit 12 corresponds to the response transmitting unit of the present invention.

Moreover, in the present invention, an RACH procedure in accordance with a high/low level of CQI is performed.

In this case, at the determination unit 7, the high/low level of the CQI included in the random access preamble is determined. When it is determined at the determination unit 7 that the CQI is low, the scheduler unit 9 outputs scheduling information (a grant for an RRC connection request signal and a grant between the relay station and the base station for transferring the RRC connection request signal) to the scheduling information generating unit 11. Then, the scheduling information generated at the scheduling information generating unit 11 is transmitted from the transmitting unit 12 to the relay station.

On the other hand, when it is not determined at the determination unit 7 that the CQI is low, scheduling information will not be generated. In this case, the response generating unit 10 is instructed to generate a random access response. Here, the CQI corresponds to the communication quality of the present invention. For this information that indicates CQI, for example, one bit information (CQI is high or low) will be sufficient.

### (Radio Terminal Device)

Next, the configuration of the radio terminal device 2 will be described. As illustrated in FIG. 1, the radio terminal device 2 includes a receiving unit 13, a reference signal acquiring unit 14, a broadcast information acquiring unit 16, a random access response acquiring unit 15 (also referred to simply as a response acquiring unit), and an RRC connection response acquiring unit 17. Moreover, the radio terminal device 2 includes a determination unit 18, a control unit 19, a resource storing unit 20, a random access preamble generating unit 21, an RRC connection request generating unit 22, and a transmitting unit 23.

The receiving unit 13 receives signals transmitted from the base station and the relay station in an RACH procedure. For example, the receiving unit 13 receives a random access response and an RRC connection response, etc. transmitted from the base station. The receiving unit 13 corresponds to the response receiving unit of the present invention.

The reference signal acquiring unit 14 detects the received power of a reference signal received at the receiving unit 13. Moreover, the broadcast information acquiring unit 16 detects parameters notified through a broadcast control channel.

The control unit 19 estimates a path loss by using the detected received power and the received transmission power. Moreover, the control unit 19 estimates the transmission power needed for the random access preamble based on the above described parameters and the path loss, and outputs the same to the preamble generating unit 21. The random access preamble generated at the preamble generating unit 21 is transmitted from the transmitting unit 23 to the base station.

When a random access response transmitted from the base station is received at the receiving unit 13, the response acquiring unit 15 outputs the information included in the random access response to the determination unit 18.

The determination unit 18 confirms if the random access preamble inputted from the response acquiring unit 15 includes a “via-relay-station flag”. Upon confirming the “via-relay-station flag”, the determination unit 18 instructs the control unit 19 to perform power ramping for the transmission power of RRC connection request. In this case, power control is performed such that the transmission power of RRC connection request is larger than the transmission power of random access preamble. The control unit 19 outputs the transmission power that has been subjected to power control power ramping) to the RRC connection request generating unit 22. Here, the control unit 19 corresponds to the transmission power control unit of the present invention.

It is noted that the method of determining the transmission power for RRC connection request signal may be a method of determining the transmission power in accordance with the received signal strength of the random access response, other than the method of performing power ramping based on the preamble transmission power as described above. For example, the control of the transmission power of RRC connection request may be performed by an open-loop power control which is generally specified from a path loss.

At the RRC connection request generating unit 22, an RRC connection request is generated based on the resource read out from the resource storing unit 20. The RRC connection request signal generated at the RRC connection request generating unit 22 is transmitted from the transmitting unit 23 to the base station at a transmission power estimated at the control unit 19. Here, the transmitting unit 23 corresponds to the message transmitting unit of the present invention.

### (Radio Relay Station Device)

Next, the configuration of the radio relay station device 3 will be described. As illustrated in FIG. 3, the radio relay station device 3 includes a receiving unit 24, a random access preamble storing unit 25 (preamble storing unit), a scheduling information acquiring unit 26, and an RRC connection request acquiring unit 27. Moreover, the radio relay station device 3 includes a determination unit 28, a control unit 29, a resource storing unit 30, and a transmitting unit 31.

The receiving unit 24 receives a message communicated between the terminal and the base station in an RACH procedure. To be specific, the receiving unit 24 receives a random access preamble and an RRC connection request transmitted from the terminal, scheduling information transmitted from the base station, and the like. Here, the receiving unit 24 corresponds to the scheduling information receiving unit and the message receiving unit of the present invention.

The preamble storing unit 25 temporarily stores a random access preamble when the random access preamble transmitted from the terminal is received at the receiving unit 24. Then, when it is determined at the determination unit 28 that relaying needs to be performed, the random access preamble is outputted to the control unit 29 and is transmitted (relayed) from the transmitting unit 31 to the base station.

The scheduling information acquiring unit 26 confirms the scheduling information when the scheduling information transmitted from the base station is received at the receiving unit 24. The scheduling information confirmed at the scheduling information acquiring unit 26 is outputted to and stored in the resource storing unit 30.

The RRC connection request acquiring unit 27 acquires an RRC connection request signal transmitted from the terminal. The RRC connection request acquired at the RRC connection request acquiring unit 27 is outputted to and stored in the resource storing unit 30.

If the resource of the inputted RRC connection request signal is the same as the resource inputted in advance from the scheduling information acquiring unit 26, the resource storing unit 30 outputs the RRC connection request signal included in the resource to the control unit 29.

The control unit 29 outputs the RRC connection request signal to the transmitting unit 31, and the RRC connection request signal is transmitted (relayed) from the transmitting unit 31 to the base station. Here, the RRC connection request signal corresponds to the message of the present invention, and the transmitting unit 31 corresponds to the message relaying unit of the present invention.

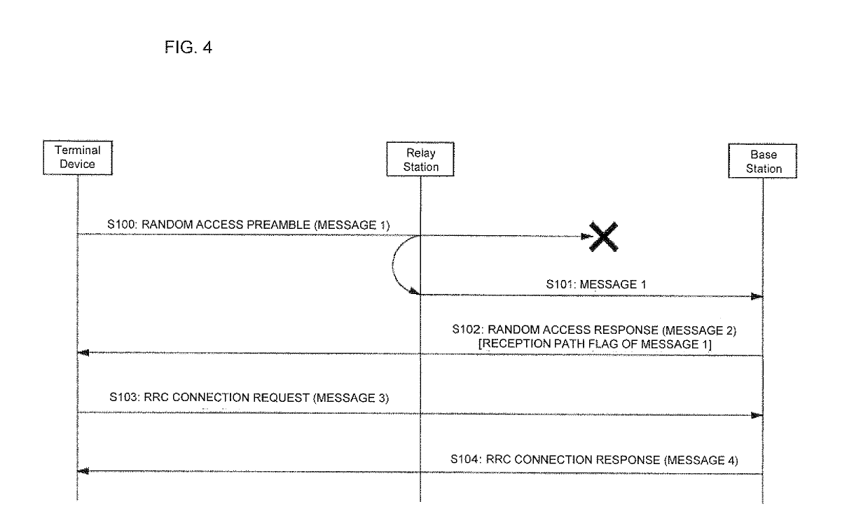

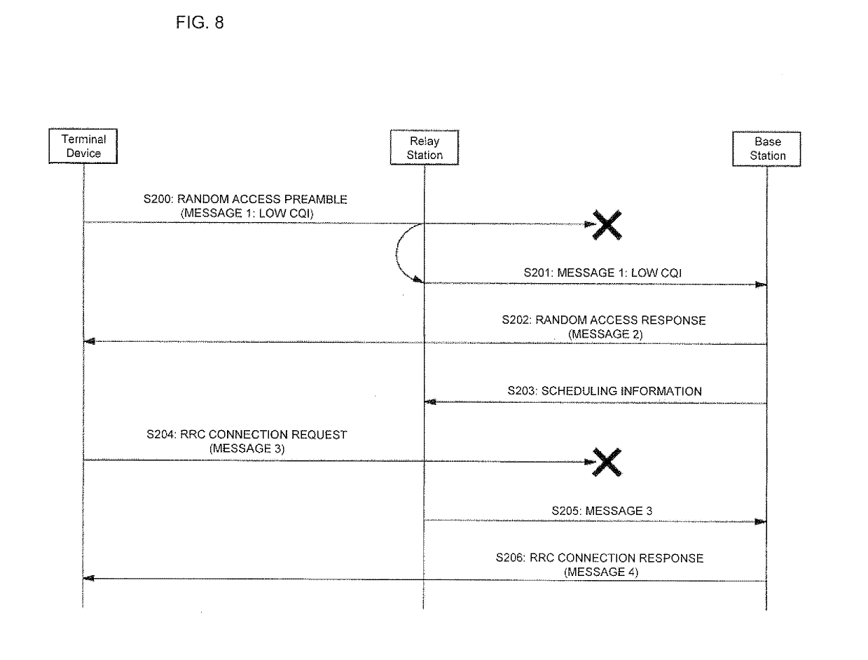

The operation of the network system configured as described above will be described by using the drawings. Here, characteristic operations of the RACH procedure of the present invention will be described using FIGS. 4 to 7, and the operations of the RACH procedure when the CQI is low will be described using FIGS. 8 to 10.

### (RACH Procedure)

FIG. 4 is a sequence diagram to illustrate a general flow of an RACH procedure in the present embodiment. As illustrated in FIG. 4, first, the terminal transmits a random access preamble (message 1) to the base station (S100). However, when the terminal is located at an edge portion (portion of the border) of the communication cell of the base station, there is a chance that the random access preamble will not reach the base station. In such a case, since the relay station and the base station use the same access slot, the relay station can receive the random access preamble transmitted to the base station by the terminal.

The relay station that has received a random access preamble addressed to the base station from the terminal transfers the random access preamble (message 1) to the base station (S101) when the signature of the random access preamble is the signature allocated to the relay station itself, or the signature of the base station to which the relay station connects. In this way, since the random access preamble is relayed at the relay station when the random access preamble does not reach the base station directly from the terminal, retransmission of the random access preamble (retransmission by the terminal) can be prevented.

When the base station receives a random access preamble with a signature for the base station from the relay station, the base station adds, in addition to the above described T-CNRI and grant, a “via-relay-station flag” that indicates the receiving path of the random access preamble, to the random access response (message 2), and reports the same to the terminal (S102).

Upon receiving the “via-relay-station flag” of random access preamble, the terminal recognizes that the transmission power of random access preamble is insufficient, and transmits a connection request (message 3) at a transmission power added with a power ramping value (S103). The transmission power is represented by the following Equation 1.

PRRC request=min{PPRACH+ΔRACH, Pmax} (Eq. 1)

Where, ΔRACH is a power ramping value (POWER_RAMP_STEP).

Upon receiving an RRC connection request, the base station transmits an RRC connection response signal (message 4) to the terminal (S104).

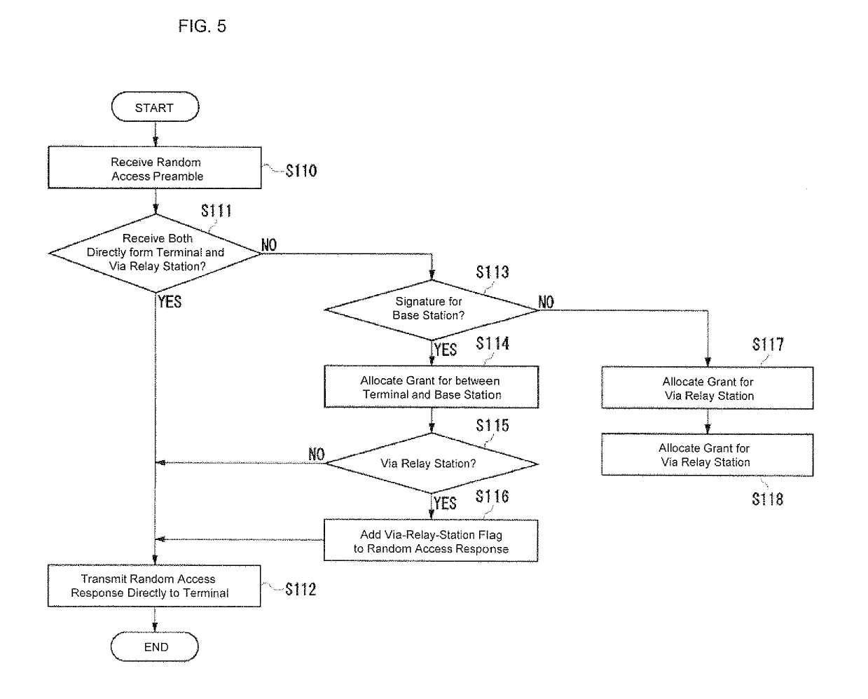

FIG. 5 is a flow diagram to illustrate the flow of the operation of the radio base station device 1 (base station) in an RACE procedure. As illustrated in FIG. 5, the base station receives a random access preamble transmitted directly from the terminal and a random access preamble relayed from the radio relay station device at the same time slot (S110).

Here, the receiving pattern of the random access preamble from the terminal that camps on the base station can be classified into three patterns. The first pattern is a pattern in which the terminal is located in a place close to the base station and therefore the reception quality of the base station is high so that the random access preamble directly reaches the base station. The second pattern is a pattern in which the terminal is located at a cell edge of the base station and of the relay station so that the random access preamble reaches the base station both directly from the terminal and from the relay station. The third pattern is a pattern in which the terminal is located at a cell edge between the base station and the relay station and therefore the reception quality between the base station and the terminal is low so that the random access preamble can be received only from the relay station.

Under this condition, the base station first confirms whether or not the reception of the random access preamble is the second pattern (receives both directly from the terminal and from the relay station)(S111). When the receiving pattern is determined to be the second pattern (receives both directly from the terminal and from the relay station), the base station recognizes the random access preamble of its own and creates a random access response message to which a resource for the RRC connection request from the terminal directly to the base station is allocated (S112).

On the other hand, when the base station receives a random access preamble transmitted directly from the terminal (the first pattern) or receives one random access preamble relayed by the relay station (the third pattern), the base station confirms if the signature of the random access preamble is the signature of its own (S113).

When, as a consequence, the signature of its own is confirmed, the base station allocates a grant between the terminal and the base station (S114) and confirms if the received random access preamble is via the relay station (S115).

When the random access preamble is received via the relay station (the third pattern), a “via-relay-station flag” is added to a random access response (S116), which is transmitted to the terminal (S112). On the other hand, when the random access preamble is not received via the relay station (when received directly from the terminal), a random access response is transmitted (5112).

Moreover, when the signature is that of the relay station which connects to the base station itself, the base station allocates a grant for resources for via the relay station (between the terminal and the relay station, and between the relay station and the base station)(3117), and transmits the random access response via the relay station (S118).

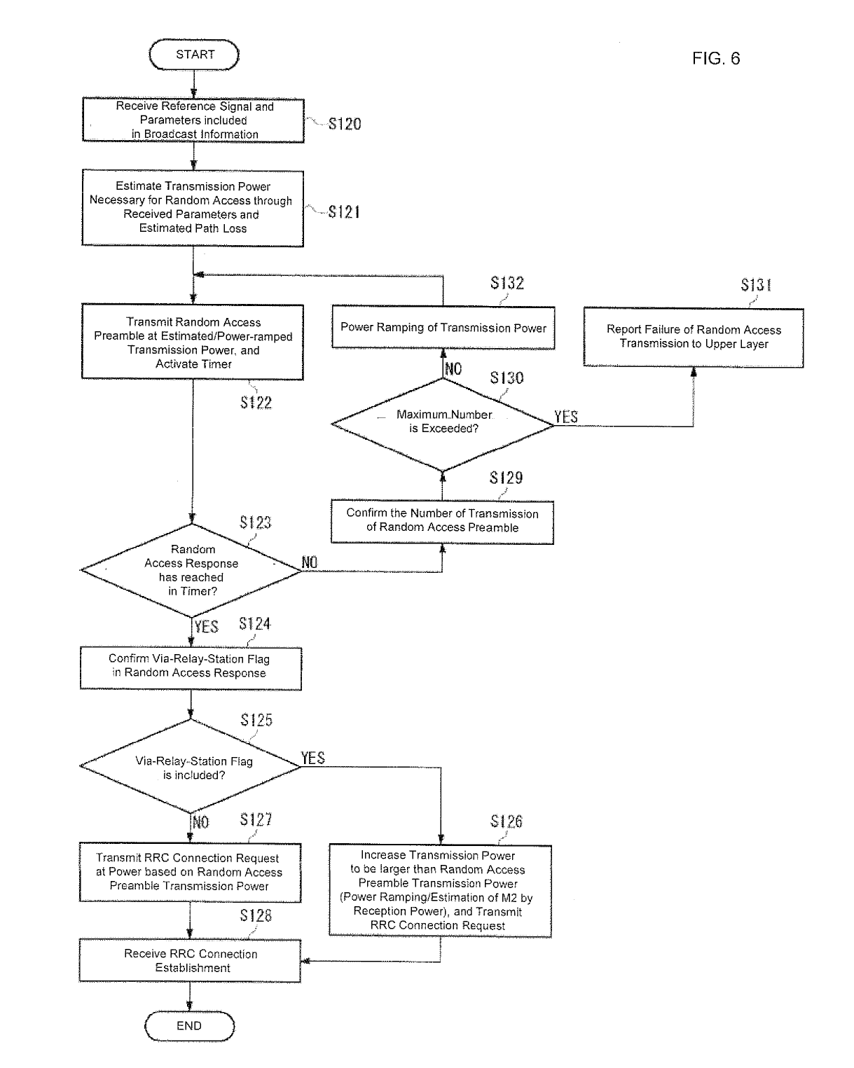

FIG. 6 is a flow diagram to illustrate the flow of the operation of the radio terminal device 2 (terminal) in the RACH procedure. As illustrated in FIG. 6, first, the terminal receives a reference signal which is needed for the estimation of path loss and parameters notified through a broadcast control channel (BCCH) (S120).

Here, the parameters will be described in more detail. The terminal estimates a transmission power needed for random access preamble transmission by using the following Equation 2.

PPRACH=min{PN_PRACH_PL+ΔPreamble, Pmax} (Eq. 2)

Where, PN_PRACH represents preamble transmission power (PREAMBLE_TRANSMISSION_POWER), PL a path loss estimated at the terminal, ΔPreamble an offset with reference to the preamble (Preamble_based offset), and Pmax the terminal maximum power. Here, ΔPreamble and Pmax are notified through the broadcast control channel (BCCH) to the terminal. On the other hand, PL represents a path loss which is the difference value between the received power of the reference signal detected at the terminal and the transmission power of the reference signal to be included in the broadcast information.

The above described PN_PRACH is represented by using the following Equation 3.

PN_PRACH=P0_PRACH+(N−1) ΔRACH (Eq. 3)

Where, P0_PRACR represents preamble transmission initial power (PREAMBLE_TRANSMISSION INTIAL_POWER), ΔRACH a power ramping value (POWER_RANP_STEP), and N the number of transmissions of random access preamble. Here, P0_PRACH and ΔRACH are notified to the terminal through the broadcast control channel (BCCH).

Upon receiving the parameters of Equations 2 and 3 as described above, the terminal estimates the transmission power (PPRACH) needed for transmitting the random access preamble by using the estimated path loss (S121). This power control method is also called as an open-loop power control.

Then, the terminal transmits the random access preamble to the base station at the estimated transmission power, and activates a timer (S122). The timer is a timer for ascertaining the success of random access preamble transmission. The base station transmits a random access response to the terminal only after receiving the random access preamble.

The terminal determines whether or not the random access response is received within the time of the timer (S123), and when the random access response is received from the base station within the time of the timer, the terminal confirms if a “via-relay-station flag” is included in the random access response (S124).

Then, it is determined if a “via-relay-station flag” is included in the random access response (S125), and when it is determined that a “via-relay-station flag” is included in the random access response, the transmission power of RRC connection request is set to a transmission power which is increased by a predetermined power ramping value (S126).

On the other hand, when a “via-relay-station flag” is not included in the random access response, the transmission power of the RRC connection request signal is set to the same value as that of the transmission value of the random access preamble (S127).

Then, the terminal receives an RRC connection establishment transmitted from the base station (S128).

On the hand, when the terminal does not receive the random access response within the time of the timer, the terminal determines that the transmission of the random access preamble fails, and confirms the number of transmissions of the random access preamble (S129).

Thereafter, it is determined if the number of transmissions of the random access preamble exceeds a maximum number of transmission (S130), and when it is determined that the maximum number of transmission is exceeded, the lower layer of the terminal reports the failure of the random access preamble transmission to the upper layer (S131).

On the other hand, when the maximum number of transmission of the random access preamble is not exceeded, the terminal performs power ramping to increase the transmission power of the random access preamble, and retransmits the random access preamble at an updated transmission power (S132).

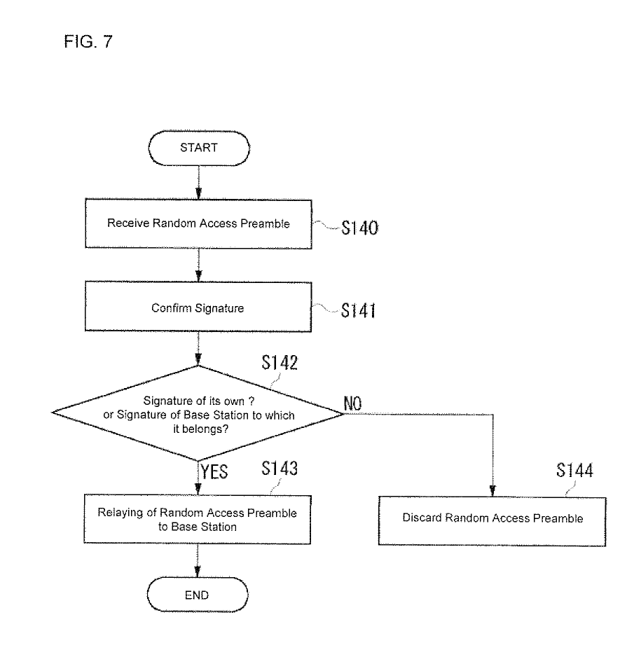

FIG. 7 is a flow diagram to illustrate the flow of the operation of the radio relay station device 3 (relay station) in the RACH procedure. As illustrated in FIG. 7, the relay station first receives a random access preamble at the receiving unit 24 (S140). Next, the received random access preamble is outputted to the determination unit 28 and the signature of the random access preamble is confirmed (S141).

When, as a result of determining whether or not the signature is the signature for the base station to which the relay station connects or the signature of the relay station itself (S142), it is determined that the signature is the signature for the connected base station or of the relay station itself, the random access preamble received from the terminal is relayed to the base station (S143). On the other hand, when it is not determined that the signature is the signature for the connected base station or of the relay station itself, the received random access preamble is sent to the control unit 29 to be discarded (S144).

(RACH Procedure when CQI is Low)

FIG. 8 is a sequence diagram to illustrate a general flow of the RACH procedure when CQI is low. This procedure is effective as a countermeasure against a case where the radio communication condition between the terminal and the base station is bad, and an RRC connection request signal cannot be received even at a transmission power estimated as described above (a transmission power that is subjected to power control).

As illustrated in FIG. 8, the terminal first transmits a random access preamble (message 1) to the base station (S200). However, when the terminal is located at an edge portion (a portion of the border) of the communication cell of the base station, the random access preamble may possibly not reach the base station. In such a case, since the relay station and the base station use the same access slot, the relay station can receive the random access preamble transmitted to the base station by the terminal.

At this time, the terminal notifies the base station of the high/low level of CQI by using one bit of the random access preamble slot. A low CQI means that the terminal is located away from the base station and the received power from the base station is low. On the other hand, when CQI is high, it is presumed that the received power from the base station is high and radio condition is sufficiently good to transmit the random access preamble to the base station. Note that here it is assumed that the resource between the base station and the relay station and the resource between the relay station and the terminal have been allocated by the base station.

The relay station that has received a random access preamble from the terminal to the base station transfers the random access preamble (message 1) to the base station when the signature of the random access preamble is the signature allocated to the relay station itself, or the signature of the base station to which the relay station connects (S201).

When the base station receives the random access preamble from the relay station, the base station adds, in addition to the above described T-C-RNTI and grant, a “via-relay-station flag” which indicates the receiving path of the random access preamble, to the random access response (message 2) and reports that to the terminal (S202).

At this moment, when the CQI indicated by the received random access preamble is low, the base station which has received the random access preamble transmitted by the terminal notifies the relay station of scheduling information (a grant for an RRC connection request signal and a grant between the relay station and the base station for transferring the RRC connection request signal) included in the random access response (S203) as well as transmits the random access response.

Upon receiving the “via-relay-station flag” of the random access preamble, the terminal recognizes that the random access preamble transmission power is insufficient, and transmits an RRC connection request (message 3) at a transmission power that is added with a power ramping value (S204).

Upon receiving the resource for the RRC connection request of the scheduling information notified from the base station, the relay station relays the RRC connection request signal (message 3) included in the resource to the base station (S205).

Upon receiving the RRC connection request, the base station transmits an RRC connection response signal (message 4) to the terminal (S206).

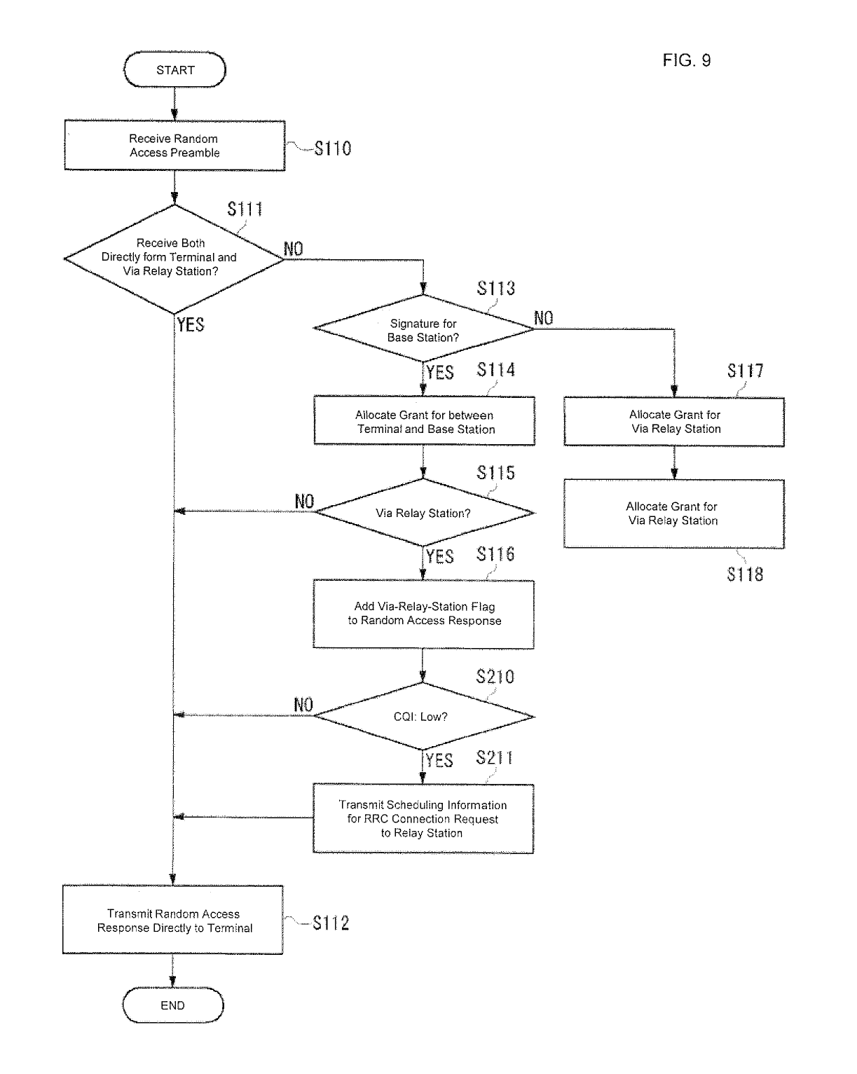

FIG. 9 is a flow diagram to illustrate the flow of the operation of the radio base station device 1 (base station) in an RACH procedure when CQI is low. Here, description will be focused on characteristic operations of the RACH procedure, and the description of the operations similar to those of FIGS. 5 (S110 to 5118) will be omitted.

As illustrated in FIG. 9, when the received random access preamble has been received via the relay station (in the case of the third pattern), after adding a “via-relay-station flag” to the random access response (S116), the base station determines the high/low level of the CQI included in the random access preamble received from the relay station (S210).

When, consequently, it is determined that the CQI is low, the base station transmits the random access response to the terminal (S112), and transmits the scheduling information between the relay station and the base station for transferring an RRC connection request signal to the relay station (S211). On the other hand, when it is determined that the CQI is high, the base station transmits the random access response to the terminal (S112).

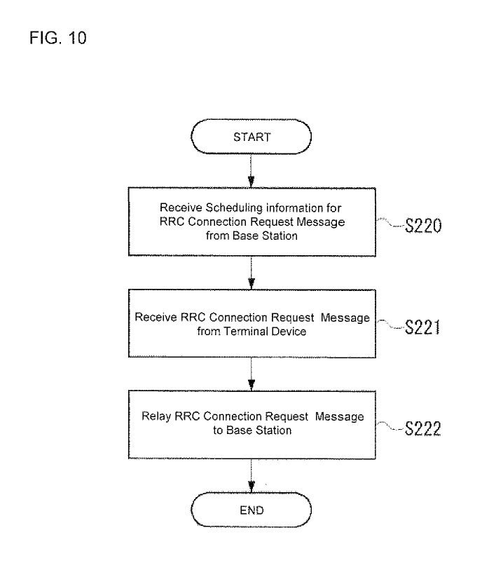

FIG. 10 is a flow diagram to illustrate the flow of the operation of the radio relay station device 3 (relay station) in the RACH procedure when the CQI is low. As illustrated in FIG. 10, the relay station receives the scheduling information including a resource (grant) for the RRC connection request signal transmitted from the base station, and a grant between the relay station and the base station for transferring the RRC connection request signal (S220).

Thereafter, upon receiving the RRC connection request signal transmitted from the terminal (S221), the relay station relays the PRO connection request received by the resource (a grant between the relay station and the base station) allocated in advance from the base station, to the base station (S222).

According to such network system of the embodiment of the present invention, by determining whether or not relaying of random access preamble has been performed at the base station, transmitting a random access response with relay flag information attached to the terminal, and performing the control of the transmission power of the terminal, it is possible to suppress an increase in the delay before the establishment of RRC connection, thereby improving the utilization effect of resources. That is, by appropriately setting the transmission power of the RRC connection request signal and thereby preventing retransmissions, it becomes possible to provide an RRC connection establishment procedure which realizes a high utilization efficiency of radio resources and a reduced delay.

In the present embodiment, at the base station, it is determined whether or not relaying of a random access preamble has been performed based on the resource information of the random access preamble. For example, when the resource of the random access preamble is the resource allocated to the terminal, it is determined that the random access preamble is received directly (without relaying) from the terminal. On the other hand, when the resource of the random access preamble is the resource allocated to the relay station, it is determined that the random access preamble has been relayed (with relaying) at the relay station. Then, relay flag information that indicates whether or not relaying has been performed is attached to the random access response to be transmitted to the terminal. At the terminal, the control of the transmission power is performed based on the relay flag information. For example, a control to increase the transmission power is performed based on relay flag information that indicates that relaying has been performed. Using relay flag information in this manner allows the terminal to recognize that when a random access preamble has not directly reached the base station (that is, when relaying has been performed). This enables the terminal to perform the control of transmission power depending on whether or not relaying has been performed. For example, when relaying has been performed, a control to increase the transmission power of RRC connection request is performed, thereby allowing for the reduction of retransmissions of RRC connection request caused by the insufficiency of transmission power. In this way, it is possible to suppress the delay before the establishment of RRC connection, thereby improving the utilization effect of resources.

That is, by the base station ascertaining the receiving path through which the random access preamble is transmitted from the terminal, improving the reception probability of the RRC connection request signal by appropriate power control thereby preventing the retransmission of RRC connection request, it is possible to reduce the delay before the establishment of RRC connection, thereby improving the utilization efficiency of radio resources.

Moreover, when a random access preamble has not directly reached the base station (that is, when relaying has been performed), scheduling information is transmitted to the relay station. The scheduling information includes relay information (for example, a grant for RRC connection request and a resource for relaying) to be used for relaying the connection request message transmitted from the terminal. This enables the relay station to relay an RRC connection request which is thereafter to be transmitted to the base station by the terminal. For example, depending on the position and situation, etc. of the terminal, such as when the terminal is located at a cell edge, the RRC connection request may not directly reach the base station even if the control of the transmission power of the terminal is performed as described above. In such a case, the RRC connection request is relayed by the relay station that has received scheduling information. This allows for the reduction of retransmissions of RRC connection request.

That is, when the reception at the base station does not succeed even though the transmission power of RRC connection request signal is decided as described above, the retransmission of RRC connection request can be prevented by the relay station relaying an RRC connection request signal. Preventing the retransmission of RRC connection request allows for the reduction of the delay before the establishment of RRC connection, thereby improving the utilization efficiency of radio resources. Moreover, preventing the retransmission allows for the prevention of the retransmission of random access preamble when the number of the transmission of RRC connection request exceeds a maximum number, thereby allowing for the reduction of the delay in the general call procedure.

Moreover, in the present embodiment, the random access preamble includes communication quality information (for example, information of CQI) between the terminal and the base station, and when the communication quality (CQI) is low, it is determined (estimated) that relaying has been performed. For example, depending on the position and situation, etc. of the terminal, such as when the terminal is located at a cell edge, the RRC connection request may not directly reach the base station even if the preceding random access preamble has arrived directly at the base station. In such a case, with reference to the communication quality (CQI) of the terminal, it is determined (estimated) whether or not relaying has been performed. This allows for the reduction of retransmissions of RRC connection request.

Moreover, at the terminal, a control to increase the transmission power of RRC connection request is performed when relaying of a random access preamble has been performed. This allows for the reduction of retransmissions of RRC connection request caused by the insufficiency of transmission power. In this way, it is possible to suppress the delay before the establishment of RRC connection, thereby improving the utilization effect of resources.

Moreover, at the terminal, a control of the transmission power of RRC connection request is performed in accordance with the received signal strength of random access response (so-called open power control). For example, when the received signal strength of random access response is low, a control to increase the transmission power of RRC connection request is performed. This allows for the reduction of retransmissions of RRC connection request caused by the insufficiency of transmission power. In this way, it is possible to suppress the delay before the establishment of RRC connection, thereby improving the utilization effect of resources.

Although the embodiments of the present invention have been described by way of example so far, the scope of the present invention will not be limited to those embodiments, and may be altered/modified depending on purposes within the scope set forth in the claims.

While preferred embodiments of the present invention which can be conceived at the present time have been described so far, it should be understood that various modifications can be made to the present embodiment and all of those modifications which are included in the spirit and scope of the present invention are intended to be included in the appended claims.

### INDUSTRIAL APPLICABILITY

As so far described, the radio base station device relating to the present invention has an effect of allowing for the suppression of the increase in the delay before the establishment of RRC connection, thereby improving the utilization effect of resources, and is useful for use in, for example, mobile communication systems, etc.

1. A radio base station device used in a base station in a radio communication system in which a relay station for relaying radio communication between the base station and a terminal is disposed in a communication cell of the base station, wherein
a different resource is allocated to each of the terminal and the relay station as a resource for communication with the base station,
the radio base station device comprising:
a preamble receiving unit which receives a random access preamble transmitted from the terminal;
a relay determination unit which determines whether or not relaying of the random access preamble has been performed, based on resource information included in the random access preamble;
a response generating unit which generates a random access response with relay flag information attached that indicates whether or not relaying of the random access preamble has been performed, based on a determination result of the relay determination unit; and
a response transmitting unit which transmits the random access response to the terminal, wherein
relay flag information that indicates that relaying of the random access preamble has been performed is a power control request that instructs the terminal to control transmission power.

2. The radio base station according to claim 1, further comprising:
a scheduling information generating unit which generates scheduling information including relay information to be used for relaying a connection request message transmitted from the terminal, when it is determined by the relay determination unit that the relaying of the random access preamble has been performed; and
a scheduling information transmitting unit which transmits the scheduling information to the relay station.

3. The radio base station according to claim 1, wherein
the random access preamble transmitted from the terminal includes communication quality information that indicates a high/low level of communication quality between the terminal and the base station; and
the relay determination unit determines that the relaying of the random access preamble has been performed when the communication quality is low.

4. A radio terminal device used in a terminal in a radio communication system in which a relay station for relaying radio communication between a base station and the terminal is disposed in a communication cell of the terminal, wherein
relay flag information that indicates whether or not relaying of a random access preamble has been performed is attached to a random access response which is transmitted from the base station to the terminal as a response to the random access preamble transmitted from the terminal to the base station,
the radio terminal device comprising:
a response receiving unit which receives a random access response transmitted from the base station;
a message transmitting unit which transmits a connection request message to the base station; and
a transmission power control unit which controls a transmission power of the connection request message based on relay flag information that indicates that relaying of the random access preamble has been performed.

5. The radio terminal device according to claim 4, wherein
the transmission power control unit controls the transmission power of the connection request message so as to be larger than a transmission power of the random access preamble based on relay flag information that indicates that relaying of the random access preamble has been performed.

6. The radio terminal device according to claim 4, wherein
the transmission power control unit controls the transmission power of the connection request message in accordance with received signal strength of the random access response.

7. A radio relay station device used in a relay station in a radio communication system in which the relay station for relaying radio communication between a base station and a terminal is disposed in a communication cell of the base station, wherein
relay information to be used for relaying a connection request message transmitted from the terminal is included in scheduling information which is transmitted from the base station when, relaying of a random access preamble transmitted from the terminal to the base station has been performed,
the radio relay station device comprising:
a scheduling information receiving unit which receives scheduling information transmitted from the base station;
a message receiving unit which receives a connection request message transmitted from the terminal; and
a message relaying unit which relays the connection request message to the base station based on the scheduling information.

8. A method of controlling transmission power, used in a base station in a radio communication system in which a relay station for relaying radio communication between a base station and a terminal is disposed in a communication cell of the base station, wherein
a different resource is allocated to each of the terminal and the relay station as a resource for communication with the base station,
the method comprising:
receiving a random access preamble transmitted from the base station;
determining whether or not relaying of the random access preamble has been performed, based on resource information included in the random access preamble;
generating a random access response with relay flag information attached that indicates whether or not relaying of the random access preamble has been performed, based on the determination result;
transmitting the random access response to the terminal; and
instructing the terminal to control transmission power by using the relay flag information that indicates that relaying of the random access preamble has been performed.

9. A method of controlling transmission power, used ire a terminal in a radio communication system in which a relay station for relaying radio communication between a base station and the terminal is disposed in a communication cell of the base station, wherein
relay flag information that indicates whether or not relaying of a random access preamble has been performed is attached to a random access response transmitted from the base station to the terminal as a response to the random access preamble transmitted from the terminal to the base station,
the method comprising:
receiving a random access response transmitted from the base station; and
controlling a transmission power of a connection request message based on relay flag information that indicates that relaying of the random access preamble has been performed, when transmitting the connection request message to the base station.

10. A method of relaying radio communication, used in a relay station in a radio communication system in which the relay station for relaying radio communication between a base station and a terminal is disposed in a communication cell of the base station, wherein
relay information to be used for relaying a connection request message transmitted from the terminal is included in scheduling information which is transmitted from the base station when relaying of a random access preamble transmitted from the terminal to the base station has been performed,
the method comprising:
receiving scheduling information transmitted from the base station;
receiving a connection request message transmitted from the terminal; and
relaying the connection request message to the base station based on the scheduling information.

11. A radio communication system in which a relay station for relaying radio communication between a base station and a terminal is disposed in a communication cell of the base station, wherein
a different resource is allocated to each of the terminal and the relay station as a resource for communication with the base station, wherein
the base station comprises:
a preamble receiving unit which receives a random access preamble transmitted from the terminal;
a relay determination unit which determines whether or not relaying of the random access preamble has been performed based on resource information included in the random access preamble;
a response generating unit which generates a random access response with relay flag information attached that indicates whether or not relaying of the random access preamble has been performed, based on a determination result of the relay determination unit; and
a response transmitting unit which transmits the random access response to the terminal, and wherein
the terminal comprises:
a response receiving unit which receives the random access response transmitted from the base station;
a message transmitting unit which transmits a connection request message to the base station; and
a transmission power control unit which controls a transmission power of the connection request message based on the relay flag information attached to the random access response.

12. The radio communication system according to claim 11, wherein
the base station comprises:
a scheduling information generating unit which generates scheduling information including relay information to be used for relaying a connection request message to be transmitted from the terminal when it is determined by the relay determination unit that relaying of the random access preamble has been performed; and
a scheduling information transmitting unit which transmits the scheduling information to the relay station, and wherein
the relay station comprises:
a scheduling information receiving unit which receives scheduling information transmitted from the base station;
a message receiving unit which receives a connection request message transmitted from the terminal; and
a message relaying unit which relays the connection request message to the base station based on the scheduling information.
